(19) United States
(12) Patent Application Publication
(10) Pub. No.: US 2026/0208248 A1
(43) Pub. Date: Jul. 23, 2026

(54) Apparatus having a coiling device

(71) Applicant: SMS group GmbH, Mönchengladbach (DE)

(72) Inventors: Andreas KASTNER, Kirchhundem (DE); Andreas LÖHR, Herdorf (DE); Thomas HOLZHAUER, Kirchhundem (DE); Magnus TREUDE, Bad Berleburg (DE); Guido FICK, Kreuztal (DE); Wolfgang FUCHS, Hilchenbach (DE)

(73) Assignee: SMS group GmbH, Mönchengladbach (DE)

(21) Appl. No.: 19/140,206

(22) PCT Filed: Nov. 9, 2023
(86) PCT No.: PCT/EP2023/081269

§ 371 Date: Jun. 17, 2025

(30) Foreign Application Priority Data
Dec. 19, 2022 (DE) 10 2022 213 901.1

(51) Int. Cl. B21B 15/00; B21B 1/22; B23Q 3/14

(52) U.S. Cl. CPC B21B 15/00; B21B 1/22; B23Q 3/14; B21B 2001/225; B21B 2015/0057

(57) ABSTRACT

The invention relates to an apparatus 100 having a coiling device 110 for winding a strip. A bridge 120 extends over the coiling device 110. In order to simplify the stationary coiling device 110 within the apparatus 100, i.e. in particular below the bridge 120, and to make maintenance safer for maintenance personnel to perform, the present invention proposes attaching at least one carrying device 126, 128 to the bridge and/or to a bridge head 121 so that parts of the coiling device 110 can thereby be easily and safely transported.

### CROSS-REFERENCE TO RELATED APPLICATION

This application is a national stage application, filed under 35 U.S.C. § 371, of International Patent Application PCT/EP2023/081269, filed on Nov. 9, 2023, which claims the benefit of German Patent Application DE 10 2022 213 901.1, filed on Dec. 19, 2022.

### TECHNICAL FIELD

The disclosure relates to an apparatus having a coiling device for winding a strip, in particular a metal strip, into a coil and having a bridge extending over the coiling device. Furthermore, the disclosure relates to a hot strip mill with said apparatus and a method for maintaining the coiling device.

### BACKGROUND

Apparatuses of said type are generally known in the prior art, e.g. from Japanese patent application JP S 55008356 A. The apparatus disclosed therein exhibits all of the features of the preamble of Patent Claim 1. Specifically, this publication describes an apparatus having a coiling device with a coiling mandrel for winding a strip, in particular a metal strip, into a coil. Three deflection shells are arranged distributed around the circumference of the coiling mandrel for guiding the strip during winding around the coiling mandrel. The deflection shells are individually adjusted by adjusting devices in the form of hydraulic cylinders. The apparatus also comprises a bridge in the form of a roller table that extends over the coiling device.

Maintenance on such stationary coiling devices is typically complex, as significant disassembly and assembly work may be required.

### SUMMARY

The disclosure is based on the object of refining a known apparatus having a coiling device, a known hot strip mill with the apparatus and known methods for maintaining the coiling device within the apparatus in such a way that maintenance can be carried out more easily and quickly and in a manner that is safer for the maintenance personnel.

This object is achieved with the apparatus as disclosed and claimed. The apparatus is characterized in that at least one carrying device is attached to the bridge and/or to the bridge heads for suspending parts of the coiling device. This, in particular, significantly simplifies and speeds up maintenance of the coiling device.

For the purposes of this description, a distinction is made between parts worn during operation of the coiling device, which must be transported out of the coiling device, and unworn or new spare parts, which must be transported into the coiling device to replace the worn parts.

At least one of the bridge heads may be a component of a driver device.

According to a first exemplary embodiment, the carrying device can be configured in the form of a hook for suspending the parts of the coiling device, or in the form of a preferably telescopic support rail or a crane, preferably each with a trolley (126′) for suspending and transporting the parts. Furthermore, the carrying device is assigned a lifting device, for example in the form of a rope or pulley, for suspending, lifting or lowering the parts of the coiling device.

At least one first carrying device can be provided, with the help of which parts, such as the adjusting devices for adjusting the deflection shells, can be transported out of the coiling device when they are worn or into the coiling device as new spare parts.

In addition to the adjusting devices, the coiling device contains further wear parts, typically in the form of pressure rollers and/or deflection shields, which are releasably fastened to the inside of the deflection shells. If these parts become worn, they are transported from the respective deflection shell to an attachment on a coil carriage with the aid of a second carrying device. If these parts need to be transported into the coiling device as unworn or new spare parts, they are transported from the coil carriage's attachment to their respective deflection shell within the coiling device with the aid of said second carrying device. In contrast to the first carrying device, the second carrying device is used to transport parts within the coiling device.

The first and second carrying devices can also be configured identically. Instead of the first and second carrying devices, it is also possible for only a single carrying device to be provided, which is then preferably configured to operate both inside and outside the coiling device.

According to a further exemplary embodiment, the pivot point for at least one first deflection shell and the deflection-shell-remote articulation point of the adjusting device adjusting the first deflection shell are attached to the bridge or to one of the bridge heads. In contrast, the pivot point for at least one second deflection shell and the deflection-shell-remote articulation point of a second adjusting device, which articulates the second deflection shell, are attached to the coiling device. The claimed partial attachment of the pivot and articulation points to the bridge or to the bridge heads creates a free space, particularly in the side areas of the coiling device, which in particular facilitates maintenance. Specifically, the free space gained in this way allows for the quick handling of the necessary worn parts or spare parts during maintenance, preferably without using the “busy” overhead crane. Maintenance can therefore often be carried out more quickly, and maintenance downtimes can be kept short.

According to a further exemplary embodiment, the bridge is supported on its inlet and outlet sides on bridge heads, which in turn are connected to a foundation via bridge pillars. The coiling device is typically arranged stationary between the bridge pillars. Therefore, the clear spaces in the side areas of the coiling device are traditionally limited. Due to the claimed partial suspension of the deflection shells and their adjusting devices on the bridge and/or on the bridge heads, the clear spaces can advantageously be increased because the space traditionally required for this purpose in the side areas is no longer needed.

The abovementioned object is further achieved by a hot rolling mill and by a plurality of methods for maintaining the coiling device. The advantages of these solutions correspond to those mentioned above with reference to said devices.

### BRIEF DESCRIPTION OF THE DRAWINGS

FIG. 1 shows the apparatus with first carrying devices;

FIG. 2 shows the apparatus with second carrying devices;

FIG. 3 shows the apparatus with a coil transport carriage in a perspective view,

FIG. 4 shows the apparatus according to FIG. 3 in a cross-sectional view; and

FIG. 5 shows a hot rolling mill with the apparatus.

### DETAILED DESCRIPTION

The invention is described in detail below with reference to the figures mentioned in the form of exemplary embodiments. In all of the figures, identical technical elements are designated by identical reference numerals. If the reference numerals, such as 114 and 116, are used without subsequent numbering, there is no distinction to be made from corresponding similar device features.

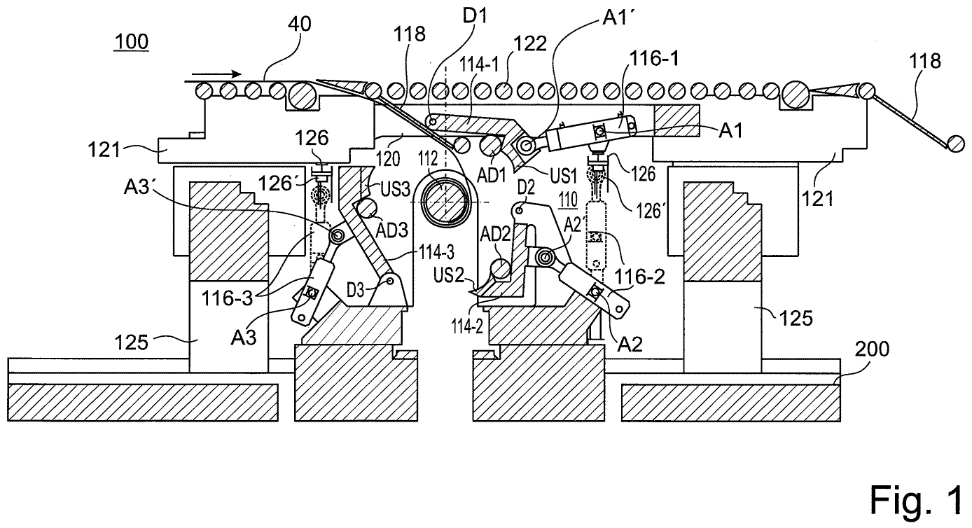

FIG. 1 shows the apparatus 100. It consists of a coiling device 110 with a coiling mandrel 112 for winding a strip 40, in particular a metal strip, into a coil, and a bridge 120 extending over the coiling device 110. The bridge 120 is supported on a foundation 200 via bridge heads 121 and bridge pillars 125. The coiling device 110 is installed stationary between the bridge pillars 125. The coiling device 110 has a pit roller table 118 on the inlet side and, next to the coiling mandrel 112, at least two deflection shells 114 distributed around its circumference for guiding the strip during winding around the coiling mandrel 112. The coiling device 110 also has adjusting devices 116 for individually adjusting the deflection shells 114 on the periphery of the coiling mandrel 112. The deflection shells 114 are each mounted so as to be rotatable around a pivot point D. The adjusting devices 116 each have a deflection-shell-side articulation point A1′, A2′, A3′, with which they are articulated to the deflection shells 114. In addition, they each have a deflection-shell-remote articulation point A1, A2, A3. The pivot point DI for the first deflection shell 114-1 and the deflection-shell-remote articulation point Al of the first adjusting device 116-1, which is used to adjust the first deflection shell 114-1, are attached to the bridge 120 or to one of the bridge heads 121. In contrast, the pivot points D2, D3 for the second and third deflection shells 114-2, 114-3 and the deflection-shell-remote articulation points A2, A3 of the adjusting devices 116-2, 116-3, which adjust the second deflection shell 114-2 and the third deflection shell 114-3, are attached to the coiling device 110 or the foundation 200. The adjusting devices 116 are each configured either in the form of a hydraulic cylinder or an electric or pneumatic actuator. The bridge 120 may, for example, be configured as a roller table with roller table rollers 122. At least some of the roller table rollers can be directly driven by an electric motor (not shown in FIG. 1). The word “directly” in this context means that at most a coupling is attached between the electric motor and the driven roller table roller 122, but not, for example, a transmission shaft.

At least one carrying device 126, 128 is attached to the bridge 120 or the bridge heads 121, preferably to the underside thereof, for transporting parts of the coiling device 110.

FIG. 1 shows first carrying devices 126, preferably with associated trolleys 126′, which are extensible or pivotable or protrude beyond the width of the coiling device 110 on the drive side AS and/or on the operating side BS. They are used in particular for transporting the adjusting devices 116 out of the coiling device 110 when they have become worn or torn after prolonged operation in the coiling device. Alternatively, these carrying devices 126 are used for bringing new or repaired adjusting devices 116 into the coiling device 110 as spare parts. The carrying devices 126 extend or are extendable, in particular, perpendicular to the plane of the drawing in FIG. 1.

A pressure roller AD1-AD3 and/or a deflection shield US1-US3 are releasably fastened to the inside of each of the deflection shells 114.

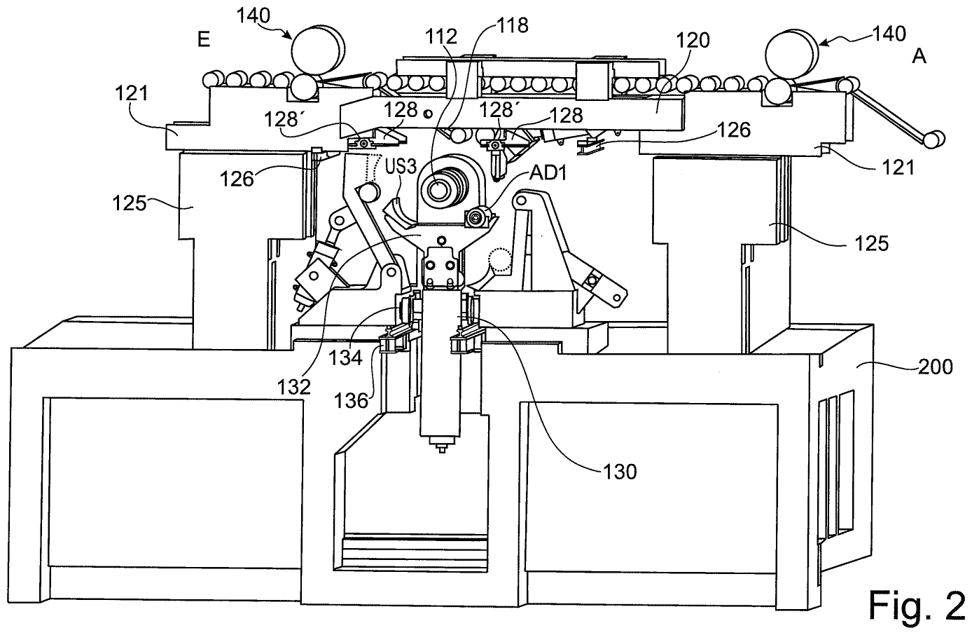

Both are also wear parts that must be replaced after a certain period of use in the operation of the coiling device 110. This is done, as shown in FIG. 2, with the aid of a coil transport carriage 130, which can be moved into and out of the coiling device 110 on rails 136 using its own wheels 134. The coil transport carriage 130 has an attachment 132 for holding the pressure rollers AD1-AD3 and/or the deflection shields US1-US3. In order to be able to transport the deflection shields US1-US3 or the pressure rollers AD1-AD3 within the coiling device 110 between the deflection shells 114 and the attachment 132, second carrying devices 128 are provided, which extend or are extendable within the coiling device 110, in particular transversely to the longitudinal axis of the coiling mandrel 112. These second carrying devices 128, like the first carrying devices 126, are attached to the bridge 120 or the bridge heads 121, preferably to the underside thereof.

Both the first and second carrying devices 126, 128 may be either extensible or extendable, for example telescopic, or rigidly configured-especially when configured as support rails. If they are configured to be extensible, associated trolleys 126′, 128′ are unnecessary. However, if the support rails are configured rigidly, it is recommended to move the parts of the coiling device along the support rails with the aid of said trolleys 126′, 128′.

The suspension of the parts on the carrying devices and/or the detachment of the parts therefrom can be achieved with the aid of a lifting device, such as a rope or pulley.

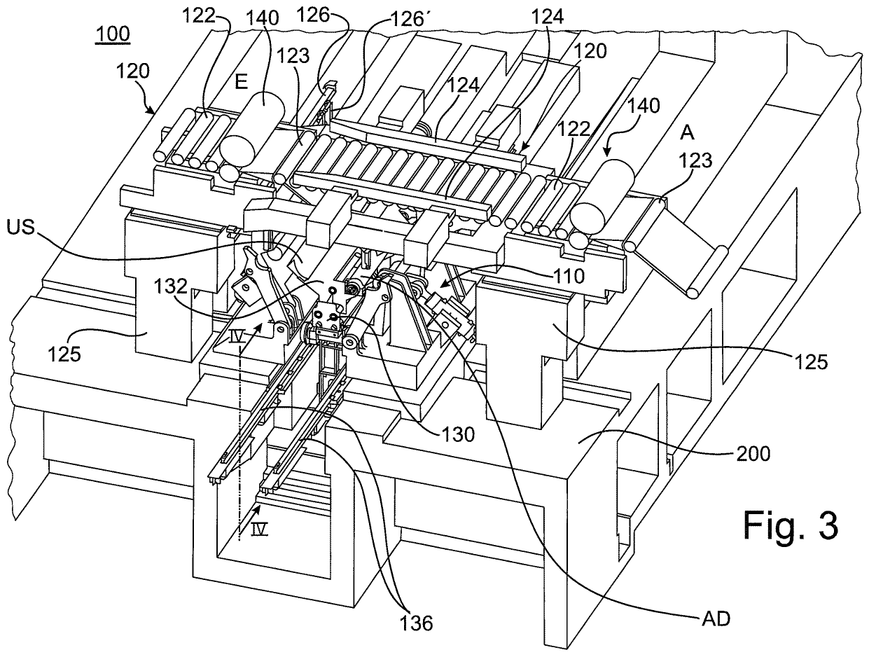

FIG. 3 shows the apparatus in a perspective view. The rails 136, with which the coil transport carriage 130 can be moved out of or into the coiling device 110, can be seen particularly clearly. Also visible is the configuration of the bridge 120 in the form of a roller table with the roller table rollers 122 and lateral guides 124 on both sides. Alternatively to the configuration as a roller table, the bridge 120 may also be configured, for example, with skids or transfer plates (not shown in FIG. 3) to transfer the strip over the coiling device 110. Also visible on the bridge 120 are diverters 123 with which the strip coming from the input side E is either fed into the coiling device 110 to be wound into the coil there, or alternatively guided over the bridge 120 to the outlet side A. The bridge may be equipped with a safety device at its outlet end-particularly if it is part of the last coiling device of a series of coiling devices-to prevent uncoiled strip from overshooting the last coiling device in an uncontrolled manner and causing damage (not shown). Finally, driver devices 140 are mounted on the inlet side E and/or on the outlet side A to convey the strip.

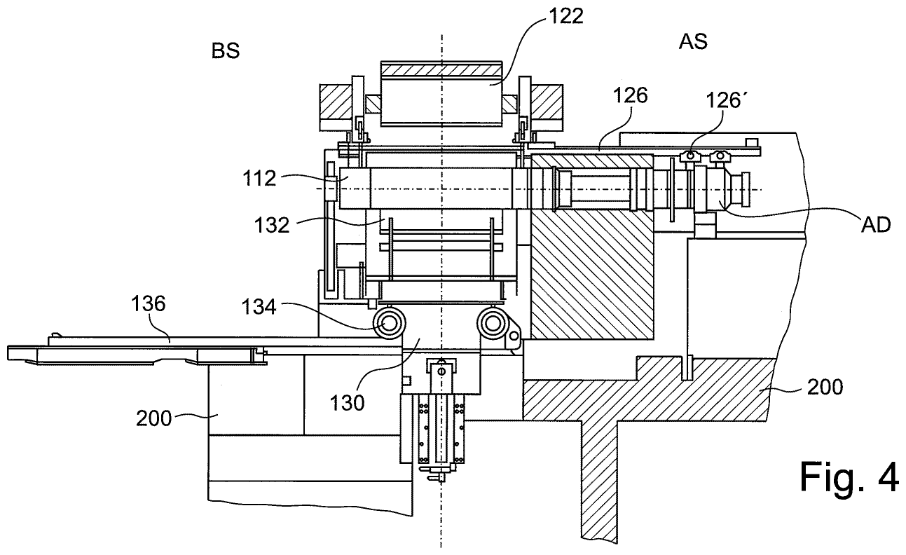

FIG. 4 shows a cross-section through FIG. 3, as indicated therein. FIG. 4 illustrates, in particular, the operating side BS and the drive side AS. The rail 136 for moving the coil carriage 130 and the carrying devices 126 with the associated trolleys 126′for moving, in particular, the adjusting devices 116 to the drive side AS are particularly clearly visible.

The present disclosure also relates to the following methods for maintaining the coiling device 110.

A first method used when carrying out maintenance concerns the removal of the at least one adjusting device 116 from the coiling device 110 when the adjusting device is worn or torn. This method provides for the following steps:
a) suspending the adjusting device 116, preferably with the aid of a lifting device (not shown in the figures) to the carrying device 126 or to its trolley 126′ within the coiling device 110;
b) releasing the adjusting device within the coiling device 110; and
c) removing the adjusting device 116 from the coiling device 110 by moving the first carrying device 126 or its trolley 126′ with the suspended adjusting device 116 onto the operating side BS or the drive side AS of the coiling device 110. The movement may also involve pivoting, particularly if the carrying device is a crane.

A further maintenance method involves fitting the at least one adjusting device into the coiling device 110 as a new or repaired spare part to replace a worn adjusting device. This method comprises the following steps:
a) extending the first carrying device 126 or its trolley 126′ to the outside of the coiling device 110 on its operating side BS or drive side AS. Extending may also involve pivoting, particularly if the carrying device is a crane.
b) suspending the adjusting device 116 on the first carrying device 126 or its trolley 126′, preferably with the aid of the lifting device;
c) moving the first carrying device 126 or its trolley 126′ with the suspended adjusting device 116 into the coiling device 110;
d) fastening the adjusting device 116 within the coiling device 110 at its articulation points; and
e) releasing the adjusting device 116 from the first carrying device 126 or its trolley 126′ or from the lifting device.

When carrying out maintenance of the stationary coiling device 110, it may also be necessary to remove the pressure rollers AD1-AD3 and/or the deflection shields US1-US3 if they are worn or torn. This method comprises the following steps:
a) inserting a coil transport carriage 130 with an empty attachment 132 for the pressure roller AD1-AD3 and/or the deflection shield US1-US3 into the coiling device 110;
b) suspending the pressure roller AD1-AD3 and/or the deflection shield US1-US3 preferably with the aid of the lifting device on a second carrying device 128;
c) releasing the pressure roller AD1-AD3 and/or the deflection shield US1-US3 from the deflection shell 114-1, 114-2, 114-3;
d) transporting the pressure roller AD1-AD3 and/or the deflection shield US1-US3 with the aid of the second carrying device 128 and preferably with its trolley 128 to the attachment 132;
e) placing the pressure roller AD1-AD3 and/or the deflection shield US1-US3 on the attachment 132 of the coil transport carriage 130 and releasing the parts from the carrying device 128; and
f) extending the coil transport carriage 130 with the pressure roller AD1-AD3 and/or the deflection shield US1-US3 out of the coiling device 110, preferably on its operating side.

Finally, the method of maintaining the stationary coiling device 110 may also provide for the fitting of new or repaired pressure rollers AD1-AD3 and/or deflection shields US1-US3 as spare parts for corresponding torn components. This fitting method provides for the following steps:
a) inserting the coil transport carriage 130 with the pressure roller AD1-AD3 and/or the deflection shield US1-US3 into the coiling device 110, typically from its operating side BS;
b) suspending the pressure roller AD1-AD3 and/or the deflection shield US1-US3 preferably with the aid of the lifting device on the second carrying device;
c) transporting the pressure roller AD1-AD3 and/or the deflection shield US1-US3 with the aid of the second carrying device 128 and preferably with its trolley 128′ from the coil transport carriage 130 to its respective deflection shell;
d) fastening the pressure roller AD1-AD3 and/or the deflection shield US1-US3 to the deflection shell (114-1, 114-2, 114-3) within the coiling device 110;
e) releasing the parts from the second carrying device; and
f) extending the coil transport carriage 130 with the emptied attachment 132 out of the coiling device 110, typically on its operating side.

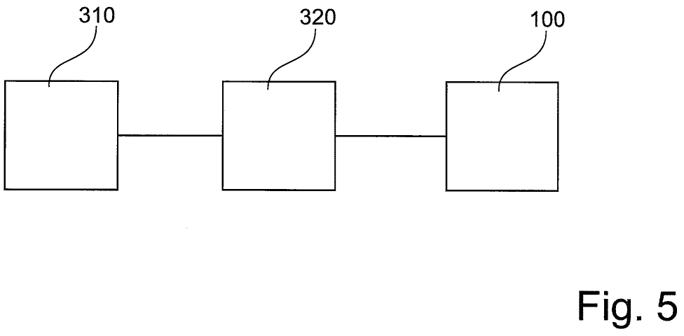

In all of the methods described, the order of the steps is not mandatory. Rather, the steps may also be performed in any other reasonable order. Finally, the present disclosure relates to a hot rolling mill 300, as shown in FIG. 5. It comprises a finishing rolling mill 310 for hot rolling the strip, optionally a cooling section 320 arranged downstream of the finishing rolling mill 310 for cooling the hot-rolled strip, and an apparatus 100, as previously described, with the stationary coiling device 110 in line with the finishing rolling mill 310 for selectively coiling the cooled hot-rolled strip.

### LIST OF REFERENCE NUMERALS

40 Strip
100 Apparatus
110 Coiling device
112 Coiling mandrel
114 Deflection shell
114-1 1st deflection shell
114-2 2nd deflection shell
114-3 3rd deflection shell
116 Adjusting device for deflection shell
116-1 1st adjusting device
116-2 2nd adjusting device
116-3 3rd adjusting device
118 Pit roller table
120 Bridge
121 Bridge head
122 Roller table rollers
123 Diverter
124 Lateral guides
125 Bridge pillar
126 1st carrying device
126′ Trolley
128 2nd carrying device
128′ Trolley
130 Coil transport carriage
132 Attachment for coil transport carriage
134 Wheels
136 Rails
140 Driver device
200 Foundation
300 Hot rolling mill
310 Finishing rolling mill
320 Cooling section
A Outlet side
AD1-AD3 Pressure roller
AS Drive side
A1 Deflection-shell-remote articulation point of the 1st deflection shell
A1′ Deflection-shell-side articulation point of the 1st deflection shell
A2 Deflection-shell-remote articulation point of the 2nd deflection shell
A2′ Deflection-shell-side articulation point of the 2nd deflection shell
A3 Deflection-shell-remote articulation point of the 3rd deflection shell
A3′ Deflection-shell-side articulation point of the 3rd deflection shell
BS Operating side
D1 Pivot point of the 1st deflection shell
D2 Pivot point of the 2nd deflection shell
D3 Pivot point of the 3rd deflection shell
E Inlet side
US1-US3 Deflection shield

1.-15. (canceled)

16. An apparatus (100), comprising:
a coiling device (110) with a coiling mandrel (112) for winding a metal strip (40) into a coil;
at least two deflection shells (114-1, 114-2, 114-3) arranged distributed around a circumference of the coiling mandrel (112) for guiding the metal strip during winding around the coiling mandrel (112);
at least two adjusting devices (116-1, 116-2, 116-3) for individually adjusting the at least two deflection shells (114-1, 114-2, 114-3) on a periphery of the coiling mandrel (112);
a bridge (120) supported on bridge heads (121) and extending over the coiling device (110); and
a carrying device (126, 128) attached to the bridge (120) and/or to the bridge heads for suspending parts of the coiling device (110).

17. The apparatus (100) according to claim 16,
wherein the carrying device (126, 128) is a hook, or a telescopic support rail, or a crane for suspending and transporting the parts of the coiling device (110); and
wherein the carrying device is coupled to a lifting device for suspending, lifting, or lowering the parts of the coiling device.

18. The apparatus (100) according to claim 16,
wherein the carrying device (126) is a support rail or a crane,
wherein the carrying device (126) is extensible or pivotable or projects beyond a width of the coiling device (110) on a drive side (AS) and/or an operating side (BS) of the coiling device (110),
wherein the carrying device (126) is configured for transporting the at least two adjusting devices (116-1, 116-2, 116-3) out of the coiling device (110) when worn, or into the coiling device (110) as spare parts.

19. The apparatus (100) according to claim 16,
wherein a pressure roller (AD1-AD3) and/or a deflection shield (US1-US3) is/are releasably fastened to an inside of each of the deflection shells (114-1, 114-2, 114-3), and
wherein a coil transport carriage (130) with an attachment (132) for the pressure rollers (AD1-AD3) and/or the deflection shields (US1-US3) is provided for transporting the pressure rollers (AD1-AD3) and/or the deflection shields (US1-US3)
out of the coiling device (110) when worn, or
into the coiling device (110) as spare parts.

20. The apparatus (100) according to claim 19,
further comprising a second carrying device (128) for transporting the deflection shields (US1-US3) and/or the pressure rollers (AD1-AD3)
within the coiling device (110) from a respective one of the deflection shells (114) to the attachment (132) of the coil transport carriage (130) when worn, or
within the coiling device (110) from the attachment (132) to a respective one of the deflection shells (114) as spare parts.

21. The apparatus (100) according to claim 20,
wherein the carrying device (126) and the second carrying device (128) are identical.

22. The apparatus (100) according to claim 16,
wherein the deflection shells are each mounted so as to be rotatable about a respective pivot point (D1, D2, D3),
wherein the at least two adjusting devices (116-1, 116-2, 116-3) each have a respective deflection-shell-side articulation point (A1′, A2′, A3′) and a respective deflection-shell-remote articulation point (A1, A2, A3),
wherein the respective pivot point (D1) for a first of the deflection shells (114-1) and the respective deflection-shell-remote articulation point (A1) of a first of the at least two adjusting devices (116-1) adjusting a first of the at least two deflection shells (114-1) are attached to the bridge (120) or to one of the bridge heads (121), and
wherein the respective pivot point (D2, D3) for a second of the deflection shells (114-2, 114-3) and the respective deflection-shell-remote articulation point (A2, A3) of a second of the at least two adjusting devices (116-2, 116-3) adjusting a second of the at least two deflection shells (114-2, 114-3) are attached to the coiling device (110).

23. The apparatus (100) according to claim 16,
further comprising a driver device (140) on an inlet side (E) of the bridge (120) for conveying the metal strip.

24. The apparatus (100) according to claim 16,
wherein the bridge heads (121) on an inlet side (E) and on an outlet side (A) of the bridge (120) are each mounted on bridge pillars (125),
wherein the bridge heads (121) and the bridge (120) are connected to a foundation (200) via the bridge pillars (125), and
wherein the coiling device (110) is arranged in a stationary manner between the bridge pillars (125).

25. The apparatus (100) according to claim 16,
wherein the bridge (120) is configured to guide the metal strip over the coiling device (100); and
wherein a diverter (123) is arranged on an inlet side (E) of the bridge for alternatively guiding the metal strip into the coiling device (110) or over the bridge (120) over the coiling device (110).

26. The apparatus (100) according to claim 25,
wherein the bridge (120) is configured as a roller table with roller table rollers (122),
wherein at least some of the roller table rollers (122) are directly driven by an electric motor, and
wherein lateral guides (124) are provided on both sides of the roller table for guiding the metal strip.

27. The apparatus (100) according to claim 16,
wherein the at least two adjusting devices (116) are each a hydraulic cylinder, an electric actuator, or a pneumatic actuator.

28. A hot rolling mill (300), comprising:
a finishing rolling mill (310) for hot rolling a strip;
a cooling section (320) arranged downstream of the finishing rolling mill (310) for cooling the strip after hot rolling; and
the apparatus (100) according to claim 16,
wherein the coiling device (110) is stationary in line with the finishing rolling mill for selectively coiling the strip.

29. A method for maintaining a stationary coiling device (110) within the apparatus (100) according to claim 17, comprising the following steps to remove the at least one adjusting device (116) when worn:
suspending the adjusting device (116) with the lifting device to the carrying device (126) or other trolley (126′) within the coiling device (110);
releasing the adjusting device within the coiling device (110); and
removing the adjusting device (116) from the coiling device (110) by moving the carrying device (126) or its trolley (126′) with the suspended adjusting device (116) onto an operating side (BS) or a drive side (AS) of the coiling device (110).

30. A method for maintaining the coiling device (110) within the apparatus (100) according to claim 17, comprising the following steps to fit an adjusting device (116) as a spare part:
extending the carrying device (126) or its trolley (126′) to an outside of the coiling device (110) on its operating side (BS) or drive side (AS);
suspending the adjusting device (116) on the carrying device (126) or on its trolley (126′) with the lifting device;
moving the carrying device (126) or its trolley (126′) with the adjusting device (116) suspended thereon into the coiling device (110);
fastening the adjusting device (116) within the coiling device (110) at its articulation points; and
releasing the adjusting device (116) from the carrying device (126) or its trolley (126′).

31. A method of maintaining the coiling device within the apparatus (100) according to claim 19, comprising the following steps to remove the pressure roller (AD1-AD3) and/or the deflection shield (US1-US3) from the coiling device (110) when worn:
inserting a coil transport carriage (130) with the attachment (132) for the pressure roller (AD1-AD3) and/or the deflection shield (US1-US3) into the coiling device (110);
suspending the pressure roller (AD1-AD3) and/or the deflection shield (US1-US3) with a lifting device on a second carrying device (128);
releasing the pressure roller (AD1-AD3) and/or the deflection shield (US1-US3) from the deflection shell (114-1, 114-2, 114-3);
transporting the pressure roller (AD1-AD3) and/or the deflection shield (US1-US3) with the second carrying device (128) and with its trolley (128′) to the attachment (132);
placing the pressure roller (AD1-AD3) and/or the deflection shield (US1-US3) on the attachment (132) of the coil transport carriage (130) and releasing the parts from the carrying device 128; and
extending the coil transport carriage (130) with the pressure roller (AD1-AD3) and/or the deflection shield (US1-US3) out of the coiling device (110), on its operating side.

32. A method of maintaining the coiling device (110) within the apparatus (100) according to claim 19, comprising the following steps to fit the pressure roller (AD1-AD3) and/or the deflection shield (US1-US3) as a spare part in the coiling device (110):
inserting the coil transport carriage (130) with the pressure roller (AD1-AD3) and/or the deflection shield (US1-US3) into the coiling device (110), from its operating side (BS);
suspending the pressure roller (AD1-AD3) and/or the deflection shield (US1-US3) with a lifting device on a second carrying device;
transporting the pressure roller (AD1-AD3) and/or the deflection shield (US1-US3) with the second carrying device (128) and with its trolley (128′) from the coil transport carriage (130) to its respective deflection shell;
fastening the pressure roller (AD1-AD3) and/or the deflection shield (US1-US3) to the deflection shell (114-1, 114-2, 114-3) within the coiling device (110);
releasing the parts from the second carrying device; and
extending the coil transport carriage (130) with the attachment (132) out of the coiling device (110), on its operating side.
